(19) United States
(12) Patent Application Publication
(10) Pub. No.: US 2020/0093292 A1
(43) Pub. Date: Mar. 26, 2020

(54) Safety Wall Hanger

(71) Applicant: John T.S. Lee, Gaithersburg, MD (US)

(72) Inventor: John T.S. Lee, Gaithersburg, MD (US)

(21) Appl. No.: 16/141,532

(22) Filed: Sep. 25, 2018

(51) Int. Cl. A47G 1/16

(52) U.S. Cl. CPC A47G 1/16; F16B 13/00

(57) ABSTRACT

A device and method for securing objects of almost any sizes and shapes to a wall is disclosed.

A hanger comprising a length of cord suitable for the size of object to be hung, a hook shaped block with screw mounting holes, a thru hole, perpendicular and slightly below to the mounting holes for passing the length of cord, and a slot parallel to the thru hole . The thru hole and the slot should be of the same size, slightly larger than diameter of the cord.

The block is mounted to a wall by screws or other means such as double sided tape, rail mount system, peg board hook etc.

The cord of suitable length for the object is inserted into the thru hole and knotted on both end. With one of the knot resting against one side of the device, the rest of the cord is then looped on the object to be hung and then inserted into the slot, letting the other knot resting against the other side of the device.

### TECHNICAL FIELD

The present invention relates to a device and method for conveniently hanging an object regardless of a shape or size to a wall for storage, by means of an anchor block secured to a wall and a length of cord that is adjustable to the size and shape of the object. One or more of this device can be used to secure objects of any size, shape and weight.

### BACKGROUND ART

There are objects that because of the shape and size are very difficult to hang on the wall because hangers are not available for that particular objects.

Objects such as long ladders, step ladders, rakes, shovels, skis, surfboards, rifles, golf bag, skateboards, fishing rods, hockey sticks, etc., are usually stored vertically, leaned against the wall, unsecured and prone to fall sideways to the floor causing damage to the valuable items, and creating hazardous situation.

This hanger facilitates the storing of the items horizontally using two or more hangers, or vertically using the hanger to prevent the items to fall to the floor.

This device provides a low-cost means to safely and reliably hang or secure objects of any shape, size and weight to a wall. The device when not mounted to a wall can also be used as a custom sized rubber-bands or reusable and reconfigurable tie-wrap to hold or bundle things together.

Other arrangements representative of prior art are disclosed in the following U.S. Pat. Nos. 2,618,419; 4,878,585; 5,567,055; 9,644,788; 6,330,949

### DISCLOSURE OF THE INVENTION

In accordance with the present invention, a device and method for securely hanging almost any shaped object by conveniently tying and untying the object to a specially designed anchor, comprising:

a length of cord which is cut to a length suitable to secure the intended object;

a block of strong solid material with (see FIG. 1 and FIG. 2):
one or more mounting holes to screw into a wall;
a thru hole for the cord perpendicular to the axis of the screw holes, slightly larger than the diameter of the cord to be used;
a slot parallel to the said hole, the same width as the diameter of the said hole.

The suitable length of cord is passed into the thru hole in the anchor and knotted on both ends so the rope can easily slide thru the hole, yet will not come off the anchor block because the knots are larger than the diameter of the hole.

Because the length of the cord is determined by the user, it can be tailored to provide very tight fit for the object to hang, taking less wall area to hang the object, providing more area for other objects. This is important in limited wall area such as gun safe door, closet door, etc.

When in use, the cord is pulled to one side to let the first knot rest against the anchor block, the free length of the cord is pulled to one side, looped or wrapped around the object and the cord is inserted into the slot where the second knot will rest against the other side of the anchor block keep the cord from slipping off the slot (see FIG. 4).

Depending on the size and weight of the object, the anchor block can be made of high strength plastic, metal wood or any other suitable material.

Depending on the load object, the size can be scaled up or down to depending on the size and weight of the object and the size and strength of the cord being used.

Because this device can not be accidentally released, it is ideal for use around the house, in the kitchen, shop, garage, and is excellent for use to secure trade tools in a mobile environment such as service vehicles where shocks and vibrations may cause objects to fall if not secured.

Therefore, it is a primary objective of the present invention to provide a device and method for securely hang objects to a wall using a cord anchor block and a suitable length of cord, securely yet very easy to put on and to release.

Another objective of the present invention to provide a device that can be made in different sizes and different materials to accommodate objects of different sizes and weights

Another objective of the invention where one end of the slot is counter-bored to provide a cup for the knot, providing a “locked” position (see FIG. 2), wherein the knot have to be pulled out of the cup to release it. The other end of the slot being flat (see FIG. 1), if the knot is on this side, sliding up the knot will release it.

Another objective of the invention is to insert the cord into one of the mounting holes to provide a device similar to a tie wrap, but reusable and reconfigurable, easy to put on and to release.

Another objective of the invention whence the cord can be of strong inelastic material such as parachute cord, braided nylon rope or steel cable.

Another objective of the invention whence the cord can be elastic material such as bungee cord.

Another objective of the invention whence multiple knots on the cord provide a convenient way to hang objects of different sizes.

The above and other objectives, and nature of the invention will be more dearly understood by reference to the following detailed description, the appended claims, and the accompanying drawings.

### BRIEF DESCRIPTION OF THE DRAWINGS

FIG. 1. is one side view of the device showing the ‘unlatched’ side of the device:
1. mounting screw holes
2. thru hole for the cord
3. slot

FIG. 2. is the other side view of the device with counter-bored cup showing the ‘latched’ side of the device:
1. mounting screw holes
2. thru hole for the cord
3. slot
4. counter-bored cup

FIG. 3. the device with the cord (5) in the thru hole knotted on the other side (not visible) and the cord (6) thru the slot with the holding knot.

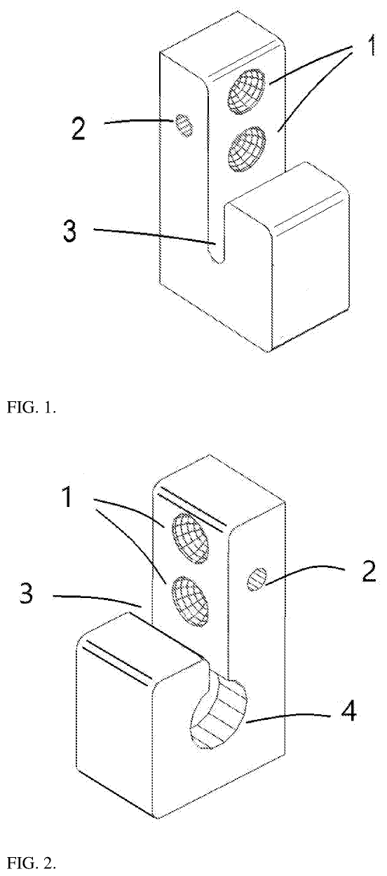

FIG. 4. showing insertion of the cord into the slot.

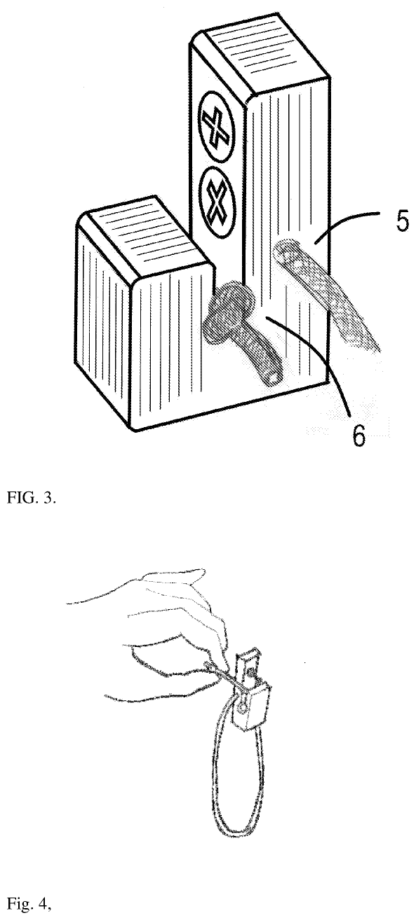

FIG. 5. showing device used in holding a long object, in this application two or more anchors are needed.

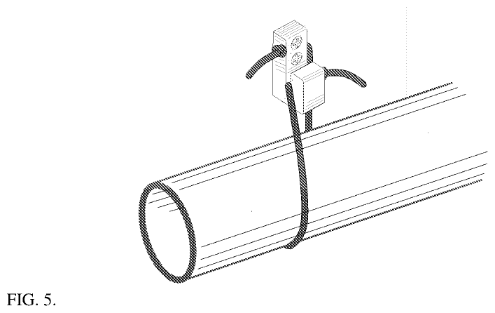

### DESCRIPTION OF A PREFERRED EMBODIMENT

The device of present invention can be made of many different materials depending on its intended use.

For the purpose of illustration, in this document, a device with two mounting holes one cord hole and one slot with one end of the slot counter-bored will he described in more detail with reference to various figures of the drawings.

I claim:

1. A device for hanging objects to a wall comprising:
anchor block means having mounting holes, cord anchor hole perpendicular to the mounting holes, a slot the same width as the anchor hole;
a length of cord passed thru the anchor hole and knotted on both ends.

2. A device of claim 1 where the anchor block can be made of metal such as aluminum, steel, brass etc., high strength plastic such as ABS, acetal, poly carbonate, etc., or any other strong materials.

3. A device of claim 1, where the anchor block has a wall mounting means such as screw holes, rail mounting system, peg board mount, double sided tape or any other types of mounting means.

4. A device of claim 1 where the anchor block has at least one thru hole perpendicular to the mounting holes axis, with a diameter slightly larger than the diameter of the cord to be used

5. The anchor block has at least one slot parallel to the cord hole, same width as the diameter of the hole.

6. One or both end of the slot of claim 5 may be counter-bored to accommodate cord knot to provide a ‘locked’ position whence to release the cord, the cord has to be lifted to free the knot from the counter-bored hole.

7. One or both end of the slot of claim 5 may be left flat, so when the knot is in this position, it can be easily slid to release.

8. One end of the slot of claim 5 is counter-bored while the other end is flat, to provide ‘easy off’ and locked positions.

9. The cord can be high strength cord such as parachute cord, braided/twisted nylon rope etc.

10. The cord of claim 9 can also be elastic cord such as bungee type cords.

11. The cord of claim 9 passed thru the hole, knotted on both ends, to fit the size of the object to be hung.

12. The cord of claim 9 can be knotted in multiple positions to accommodate objects of different sizes.

13. When not mounted to a wall, the device of claim 1, with bungee cord can be used as reconfigurable/reusable tie wrap.
